(19) United States
(12) Patent Application Publication
(10) Pub. No.: US 2008/0095078 A1
(43) Pub. Date: Apr. 24, 2008

(54) System and method for providing a calling-party-designated ring announcement to a called party terminal

(75) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/585,021

(22) Filed: Oct. 23, 2006

(51) Int. Cl. H04L 12/16

(52) U.S. Cl. 370/259

(57) ABSTRACT

A system and method of providing Calling-Party-Designated Ring Announcements (CPDRA) is provided. The Calling Party designates a Ring Announcement (RA) of his/her choice and subsequently makes a call to the Called Party. A CPDRA Indicator is sent from the Originating End to the Terminating End of the telecommunications network indicating that the call a CPDRA call. The RA is played by a suitable Called Party terminal to alert the Called Party of an incoming call.

### BACKGROUND OF THE INVENTION

This invention relates to a system and method for call handling and more specifically to a system and method for generating and delivering a Calling-Party-Designated Ring Announcement to a Called Party terminal for alerting the Called Party of an incoming call.

One of the more popular features of wireless phones enables the Called Party to select a customized Ring Tone. A Ring Tone, also known as a Ring, or a Ring Announcement, is an audible alert played by the phone to alert the user of the receipt of an incoming call. Customized Ring Tones enable the phone's user, the Called Party, to substitute an audio clip, also known as audio media, for the standard ring tone played as the alert for incoming calls. This feature allows subscribers to customize their telecommunications services and express themselves in unique and creative ways.

However, there is currently no way for the Calling Party to be distinguished by the Called Party's Ring Tone, other than possibly falling into one of a few categories specified in advance by the Called Party with a customized Ring Tone. The present invention contemplates a new and improved that resolves the above-referenced difficulties and others.

### SUMMARY OF THE INVENTION

A system and method of providing Calling-Party-Designated. Ring Announcements is provided.

In one aspect of the invention the method includes a Calling Party designating a Ring Announcement, sending a Calling-Party-Designated Ring Announcement Indicator from the Originating End to the Terminating End in call control messaging, sending the Calling-Party-Designated Ring Announcement to the Terminating End in the form of audio media in the call control messaging, determining that the Called Party terminal accepts Calling-Party-Designated Ring Announcement calls, and playing the Called Party Designated Ring Announcement at the Called Party terminal to indicate receipt of an incoming call.

In another aspect of the invention the system includes means for sending a Calling-Party-Designated Ring Announcement Indicator from the Originating End to the Terminating End in call control messaging, means for sending a Calling-Party-Designated Ring Announcement audio media content from the Originating End to the Terminating End in call control messaging, means for determining that the Called Party terminal accepts Calling-Party-Designated Ring Announcement calls, and means for playing the Called Party Designated Ring Announcement at the Called Party terminal to indicate receipt of an incoming call.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating telecommunications network including a system for providing Calling-Party-Designated Ring Announcements in accordance with the invention;

FIG. 2 is a flow chart illustrating steps of a method of Calling-Party-Designated Ring Announcements in accordance with the invention; and

FIG. 3 is a flow chart illustrating further steps of a method of Calling-Party-Designated Ring Announcements in accordance with the invention.

### DETAILED DESCRIPTION

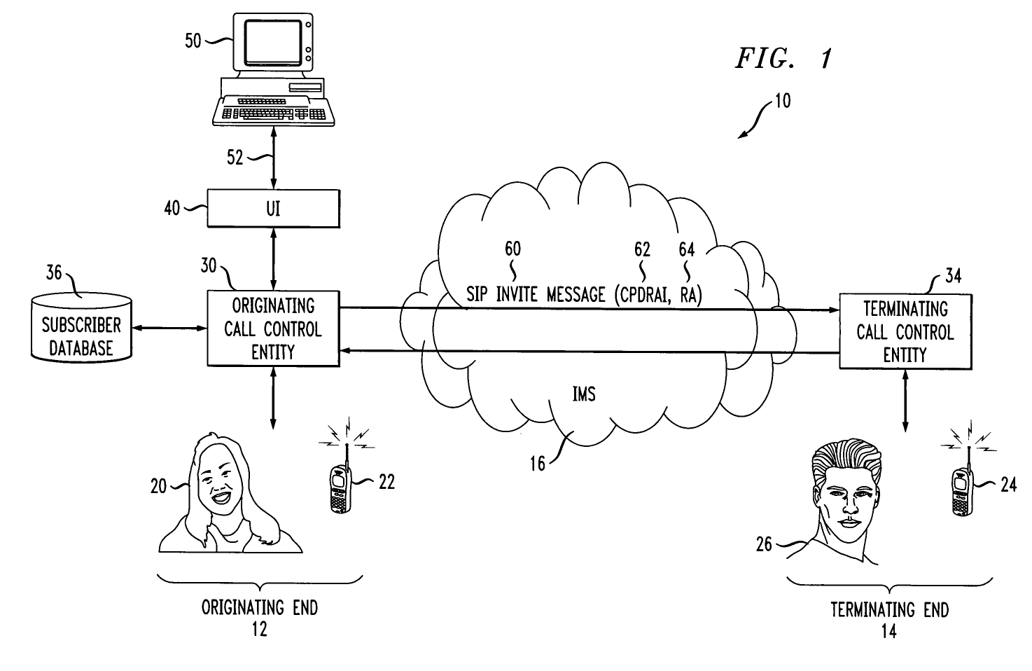

Referring now to the drawings wherein the showings are for purposes of illustrating the exemplary embodiments only and not for purposes of limiting the claimed subject matter, FIG. 1 provides a view of a system into which the presently described embodiments may be incorporated.

As shown generally, FIG. 1 includes a block diagram illustrating a portion of a telecommunications network, shown generally at 10, for providing call delivery of a Calling-Party-Designated Ring Announcement (CPDRA) call across the network from an Originating End 12 to a Terminating End 14. The telecommunications network 10 includes an Internet Protocol Multimedia Subsystem (IMS) network 16 and can also include portions of a wireless network, also known as a cellular network, a landline network, and others, connected thereto.

The example implementation of the CPDRA feature provided herein, which should not be considered limiting, uses an IMS compatible call based on Session Initiation Protocol (SIP) sent from the Originating End 12 to the Terminating End 14 across the IMS network 16. The SIP messaging protocol performs session control, including creating, modifying and terminating multimedia sessions supporting both packet-switched and circuited phone systems.

A Calling Party 20 uses a Calling Party terminal 22, also referred to as User Equipment (UE) or a phone, located at the Originating End 12 of the network 10, to place a call to a Called Party Destination 24, also referred to as the Called Party terminal, or UE, or phone, located at the Terminating End 14. The Calling Party 20 and Calling Party Terminal 22 are, therefore, defined as Originators, since the call originates therefrom. The Calling Party terminal 22 can be a wireless or cellular terminal, a landline terminal, an IMS terminal, a VOIP terminal, or other device or system capable of making, or originating, the call.

The Called Party terminal 24 can be a wireless or cellular terminal, a landline terminal, an IMS terminal, a VOIP terminal or other device capable of receiving the call. In the example provided, the Called Party terminal 24 is a SIP enabled device. Calls are typically routed to the Called Party terminal 24 using a Directory Number, also known as a phone number, for that destination via Call Control Messaging, examples of which can include SIP messaging. The Directory Number can also be a Universal Resource Locator (URL) for use with IP-based networks.

An Originating Call Control Entity 30 serves the Calling Party Terminal 22 by setting up the call and routing the call towards the Terminating End 14 using call control messaging as shall be described in further detail below. The Originating Call Control Entity 30 is, therefore, also referred to as an Originator, and is disposed at the Originating End 12 of the network 10.

A Terminating Call Control Entity 34 serves the Called Party 26, receiving the call control messaging from the Originating Call Control Entity 30, and setting up and routing the call to the proper Called Party destination 24. The Terminating Call Control Entity 34 is located at the Terminating End 14 of the network 10. The Originating and/or Terminating Call Control Entities 30, 34 can be 5 ESS switches, IMS-compatible systems, UMTS/CDMA/GSM Mobile Switching Centers, or other network nodes suitable for the corresponding network 10.

A Subscriber Database 36, also known as a Home Location Register (HLR) or Home Subscriber Server (HSS) is connected to the Originating Call Control Entity 30 for storing subscription information for the Calling Party. The Subscriber Database 36 can store the audio media used for the Ring Announcement as described in further detail below.

A User Interface (UI) 40 is provided for enabling the Calling Party 20 to designate Ring Announcements, creating them and storing them in a manner as described below. The UI 40 can be located in the Calling Party UE 22. Alternatively, the UI 40 can be provided by the network 10 such as on an Application Server which can be accessed by the Calling Party via his/her UE 22 or via a computer 50 connected thereto by the Internet 52. The UI 40 can even be provided by the Service Provider in the form of an operator or an automated system recognizing voice commands if so desired.

The system and method of call delivery described herein includes providing an indicator in call control signaling sent from the Originating End 12 of the network to the Terminating End 14 which indicates that the call is to be a CPDRA call. The indicator, referred to herein as a CPDRA Indicator (CPDRAI), can be a SIP command or it can be included in a SIP command such as by using Session Description Protocol (SDP) as described in further detail below. The CPDRA call provides a Ring Announcement (RA) that has been designated by the Calling Party to the Called Party terminal 24 for providing an audible alert, referred to herein as a Ring Announcement, indicating that the terminal is receiving an incoming call. The CPDRA Indicator can be considered to be an Originator-initiated indicator, because the Terminating End 14 is not required to request, or prompt, the Originator to provide the indicator.

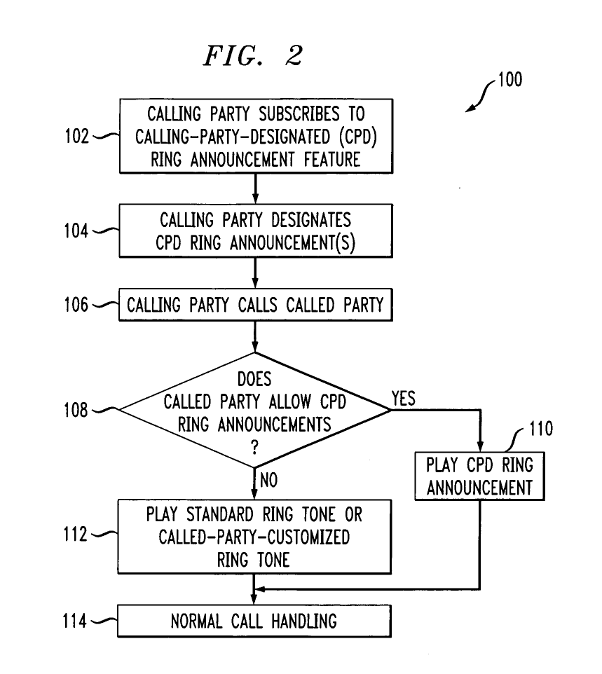

Referring now to FIG. 2, the method of operation of a system for providing CPD Ring Announcements is described generally at 100. A Calling Party 20 subscribes to the CPD Ring Announcement feature at 102. The Service Provider responsible for providing telecommunications service to the Calling Party 20 can offer CPD Ring Announcement feature as a stand alone feature or part of a package subscription features or in other manners. The Calling Party 20 can sign up for the CPD Ring Announcement feature by contacting the Service Provider using the User Interface (UI) 40, such as by using a computer 50 connected to the User Interface 32 via the Internet, using his or her User Equipment 22, or speaking to a Service Provider Operator functioning as the User Interface 40 via any phone.

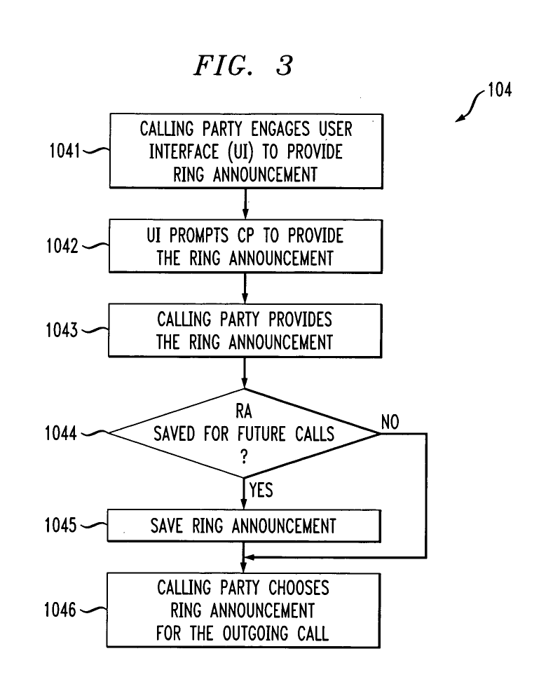

The Calling Party then designates a CPD Ring Announcement at 104. The Calling Party can designate the CPDRA, also referred to as the RA, in a variety of ways. Referring now to FIG. 3, the Calling Party engages the User Interface 40 to provide a RA at 1041. The UI 40 can be provided in the Calling Party UE 22 or it can be provided by in the variety of other manners as described above.

The User Interface 40 prompts the Calling Party 20 to provide the Ring Announcement at 1042 and the Calling Party provides the Ring Announcement at 1043. The Calling Party 20 can provide a spoken Ring Announcement via the UE 22 by speaking it into the UE microphone for recording, or via the computing device 50 and network connection 52 by speaking it into the computing device's microphone and transmitting it to the UI 40 for recording as a known audio file, also known as audio media content files. Alternatively, the Calling Party 20 can record a non-spoken Ring Announcement by playing it into the microphone of the UE 22 or computing device. As another alternative, the Calling Party 20 can provide a pre-recorded audio file to the UE 22 or the UI 40. Examples of such files can include, but are not limited to a .wav file, any suitable MPEG file, an MP3 file, or other known audio files, also known as audio media content files.

Next, it is determined if the Ring Announcement is to be saved for future calls at 1044. If the Ring Announcement is to be saved for use for future calls, the audio file is saved at 1045 and identified by an indicator, such as using a file name or a file location. The Ring Announcement audio file can be saved in the memory of the UE 22, or it can be saved on the network such as in the HSS or Subscriber Database 36.

The Calling Party 20 chooses the Ring Announcement to be used for the outgoing call at 1046. The Calling Party 20 can select the Ring Announcement on a per-call basis. For example, the Calling Party can select the Ring Announcement when making the outgoing call at 106 below. For Ring Announcements selected on a per-call basis, the Calling Party can designate a Ring Announcement recorded just prior to, or as part of, the current outgoing call, whether this RA was saved in 1045 or not. For example, the Calling Party can record a one-time RA in 1043, such as speaking “Hey Bob, it's John Doe calling”, and use this RA during the current outgoing call. Or, the Calling Party can select a pre-recorded RA audio file stored in the network 10 or in the UE 22 as described above for the current outgoing call.

The Calling Party can also select the Ring Announcement in 1046 based on the Called Party, such that a specific RA, saved in 1045 above, can be associated with a Called Party, or a group of Called Parties if so desired. The Calling Party can make this selection and association at any time, including prior to making the outgoing call. This selection can be made via the UI 40 using the UE 22 or a computer 50 connected thereto. The association between the RA and the Called Party can be saved in the UE 22 or it can be saved on the network 10 such as at the serving MSC 30. In this manner, the CPDRA is automatically selected when the Calling Party 20 calls the Called Party 26. The Calling Party 20 can select a different RA for a particular Called Party and store this association at any time. The Calling Party 20 can also use the same CPDRA for every outgoing, regardless of the Called Party, if so desired. In this example, the Originating Call Control Entity receives the same Ring Announcement from the UE 22 via a SIP message using the SDP protocol, or alternatively it retrieves the same one from the network 10 and sends it to the Terminating Call Control Entity 34 via a SIP message using the SDP protocol for every call made thereto.

Referring again to FIG. 2, the Calling Party 20 calls the Called Party 26 at 106. The Calling Party 20 can designate this particular outgoing call as being a CPDRA call using a UI in the UE 22, or by pressing a hot key on the UE indicating such. Such a designation is then reflected in the call control messaging sent from the Originating Call Control Entity 30 to the Terminating Call Control Entity 34 using the CPDRAI. Alternatively, every outgoing call the Calling Party 20 makes can be automatically designated as a CPDRA call using the CPDRAI in the call control messaging sent by the Originating Call Control Entity 30.

In the example provided herein, a SIP Invite Request message is sent from the Calling Party terminal 22 to the Originating Call Control Entity 30, and then to the Terminating Call Control Entity 34 via the IMS network 16. The SIP Invite message 60 includes the CPD Ring Announcement indicator 62, indicating that the call is to be a CPDRA call. The CPDRAI 62 is a SIP compatible indicator, which can include a new SIP command. The SIP Invite Request message also includes the Ring Announcement including the audio media to be played by the Called Party terminal 24. If the Ring Announcement media content is stored in the network 10, the Originating Call Control Entity retrieves it and includes the audio media clip in the SIP call control messaging. For example, the audio content used for Ring Announcement can be included in the SIP Invite Request using SDP.

Next, it is determined whether the Called Party terminal 24 allows CPDRA calls at 108. The Terminating Call Control Entity 34 determines this using suitable logic. If the Called Party allows CPDRAs, the caller's ring announcement is played by the Called Party terminal 24 at 110, in lieu of a customized ring tone or a standard ring tone, to alert the Called Party 26 of an incoming call. For example, the Calling Party's custom Ring Announcement of “Hey Bob, it's John Doe calling” is played by the Called Party terminal 24 as an alert. Normal Call handling is then used hereinafter at 114.

If it is determined that the Called Party terminal 24 does not allow CPDRAs at 108, the RA is stripped from the SIP Invite Request message and a standard ring announcement, or one designated by the Called Party, is played at 112. Normal Call handling is then used hereinafter at 114.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of call delivery from an Originating End to a Terminating End in a telecommunications network comprising:
a Calling Party designating a Ring Announcement to be played by a Called Party terminal at the Terminating End to alert the Called Party of the receipt of an incoming call;
the Calling Party calling the Called Party;
sending a Calling-Party-Designated Ring Announcement Indicator from the Originating End to the Terminating End in call control messaging;
sending the Calling-Party-Designated Ring Announcement in the form of audio media in the call control messaging;
determining that the Called Party terminal accepts Calling-Party-Designated Ring Announcement calls; and
playing the Called Party Designated Ring Announcement at the Called Party terminal to indicate receipt of an incoming call.

2. The method defined in claim 1 further comprising sending a Calling-Party-Designated Ring Announcement Indicator from the Originating End to the Terminating End in a SIP Invite Request call control message.

3. The method defined in claim 1 further comprising sending a Calling-Party-Designated Ring Announcement Indicator in a SIP command using Session Description Protocol.

4. The method defined in claim 1 further comprising sending a Calling-Party-Designated Ring Announcement audio media content to the Called Party terminal using a SIP command via Session Description Protocol.

5. The method defined in claim 1 further comprising the Calling Party recording a Ring Announcement for a one-time use prior to calling the Called Party.

6. The method defined in claim 1 further comprising the Calling Party recording a Ring Announcement and storing it for future calls.

7. The method defined in claim 6 wherein the Ring Announcement is stored as an audio media content file in the Calling Party terminal.

8. The method defined in claim 6 wherein the Ring Announcement is stored as an audio media content file in a subscriber database.

9. The method defined in claim 8 wherein the Originating Call Control Entity retrieves the Ring Announcement and sends it to the Terminating Call Control Entity.

10. A system for call delivery from an Originating End to a Terminating End in a telecommunications network comprising:
means for a Calling Party designating a Ring Announcement to be played by a Called Party terminal at the Terminating End to alert a Called Party of the receipt of an incoming call;
means for sending a Calling-Party-Designated Ring Announcement Indicator from the Originating End to the Terminating End in call control messaging;
means for sending a Calling-Party-Designated Ring Announcement audio media content from the Originating End to the Terminating End in call control messaging;
means for determining that the Called Party terminal accepts Calling-Party-Designated Ring Announcement calls; and
means for playing the Called Party Designated Ring Announcement at the Called Party terminal to indicate receipt of an incoming call.

11. The system defined in claim 10 further comprising means for sending a Calling-Party-Designated Ring Announcement Indicator from the Originating End to the Terminating End in a SIP Invite Request call control message.

12. The system defined in claim 10 further comprising means for sending a Calling-Party-Designated Ring Announcement Indicator in a SIP command using Session Description Protocol.

13. The system defined in claim 10 further comprising means for sending a Calling-Party-Designated Ring Announcement audio media content to the Called Party terminal using a SIP command via Session Description Protocol.

14. The system defined in claim 10 further comprising means for recording the Ring Announcement from the Calling Party for a one-time use prior to calling the Called Party.

15. The system defined in claim 10 further comprising means for storing the recorded Ring Announcement for future calls.

16. The system defined in claim 15 wherein the means for storing the Ring Announcement include the Calling Party terminal.

17. The system defined in claim 15 wherein the means for storing the Ring Announcement include a Subscriber Database.
